(19) United States
(12) Patent Application Publication
(10) Pub. No.: US 2024/0044535 A1
(43) Pub. Date: Feb. 8, 2024

(54) SYSTEMS AND METHODS FOR LIMITING APPLIANCES WITH FANS

(71) Applicant: Haier US Appliance Solutions, Inc., Wilmington, DE (US)

(72) Inventors: Joshua Duane Longenecker, Louisville, KY (US); Bryan Isaac D'Souza, Louisville, KY (US); Andrew Poos, Louisville, KY (US)

(21) Appl. No.: 17/882,810

(22) Filed: Aug. 8, 2022

(51) Int. Cl. F24F 11/49; G01P 3/44

(52) U.S. Cl. CPC F24F 11/49; G01P 3/44

(57) ABSTRACT

An appliance includes a heater and a fan. The fan is configured for generating a fan feedback signal indicative of a speed of the fan. A comparator is in signal communication with the fan. The comparator is configured to convert the fan feedback signal into a direct current signal. A heater relay is in communication with the comparator. The relay is configured to open in response to the direct current signal being less than a threshold value, and to close in response to the direct current signal being greater than the threshold value.

### FIELD OF THE INVENTION

The present subject matter relates generally to systems and methods for limiting appliances with fans, more particularly limiting components within such appliances.

### BACKGROUND OF THE INVENTION

Air conditioners or air conditioner units are conventionally used to adjust the temperature within structures, such as dwellings and office buildings. One-unit type room air conditioners, such as single package vertical units (SPVU) or package terminal air conditioners (PTAC), are frequently used to adjust the temperature in a single room or group of rooms of a structure. Air conditioner units with flammable refrigerants require a way of allowing or disallowing operation of components with ignition sources (e.g., wire heater).

### BRIEF DESCRIPTION OF THE INVENTION

Aspects and advantages of the invention will be set forth in part in the following description, or may be apparent from the description, or may be learned through practice of the invention.

In one example embodiment, an appliance includes a heater and a fan. The fan is configured for generating a fan feedback signal indicative of a speed of the fan. A comparator is in signal communication with the fan. The comparator is configured to convert the fan feedback signal into a direct current signal. A heater relay is in communication with the comparator. The relay is configured to open in response to the direct current signal being less than a threshold value, and to close in response to the direct current signal being greater than the threshold value.

In another example embodiment, an appliance includes a heater and a fan. The fan is configured for generating pulses of a fan feedback signal indicative of a speed of the fan. A resistor and a capacitor are in signal communication with the fan. The resistor and the capacitor are configured to identify a quantity of pulses of the fan feedback signal. A heater relay is in communication with the resistor and the capacitor. The relay is configured to open in response to the quantity of pulses being less than a threshold value, and to close in response to the quantity of pulses being greater than the threshold value.

In another example embodiment, a method for operating an appliance includes operating a fan of the appliance. Converting an output signal of the fan into a direct current signal. The output signal of the fan indicative of a speed of the fan. Comparing the direct current signal to a threshold value. Deactivating a heater of the appliance in response to the direct current signal being less than the threshold value.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an air conditioning appliance according to example embodiments of the present disclosure.

FIG. 2 provides a partially transparent elevation view of the example air conditioner unit of FIG. 1.

FIG. 3 provides a cut-away perspective view of a housing of the example air conditioner unit of FIG. 1, with an access door and access door frame of an access door assembly detached.

FIG. 4 provides a method of operating an appliance in accordance with aspects of the present disclosure.

FIG. 5 provides a schematic of a hardware circuit of the air conditioning appliance of FIG. 1.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “includes” and “including” are intended to be inclusive in a manner similar to the term “comprising.” Similarly, the term “or” is generally intended to be inclusive (i.e., “A or B” is intended to mean “A or B or both”). The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. Furthermore, as used herein, terms of approximation, such as “approximately,” “substantially,” or “about,” refer to being within a ten percent margin of error.

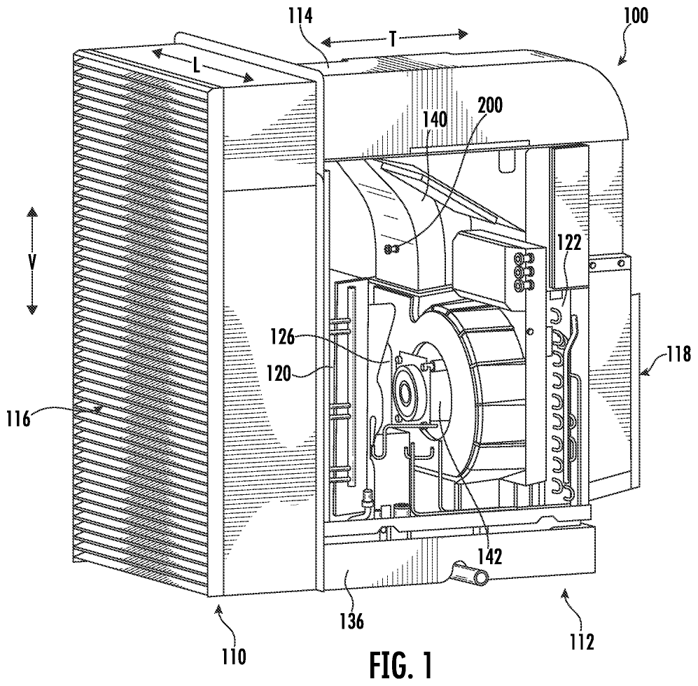

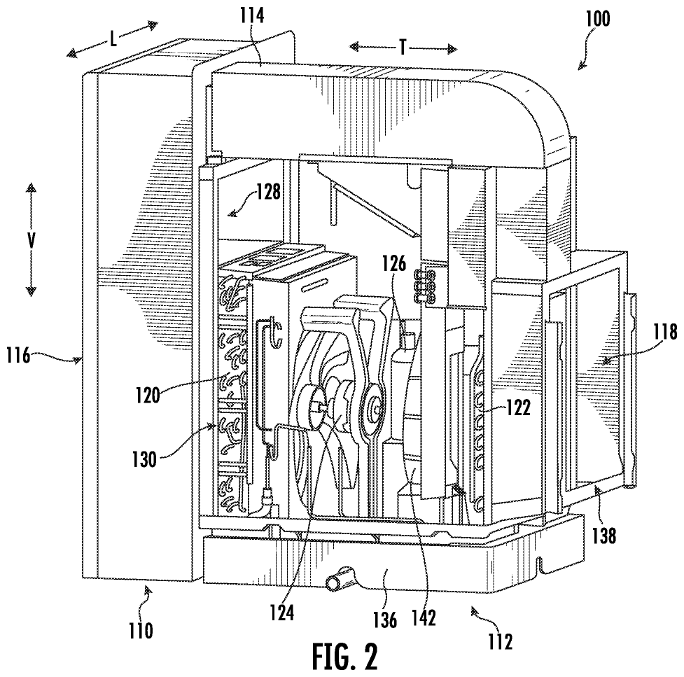

Turning now to the figures, FIGS. 1 through 3 illustrate an example air conditioning appliance (e.g., air conditioner 100). As shown, air conditioner 100 may be provided as a one-unit type air conditioner 100, such as a single-package vertical unit. Air conditioner 100 includes a housing 114 supporting an indoor portion 112 and an outdoor portion 110. Generally, air conditioner 100 defines a vertical direction V, lateral direction L, and transverse direction T that are mutually perpendicular, e.g., such that an orthogonal coordinate system is generally defined.

In some example embodiments, housing 114 contains various components of the air conditioner 100. Housing 114 may include, for example, a rear opening 116 (e.g., with or without a grill or grate thereacross) and a front opening 118 (e.g., with or without a grill or grate thereacross) may be spaced apart from each other along the transverse direction T. The rear opening 116 may be part of the outdoor portion 110, while the front opening 118 is part of the indoor portion 112. Components of the outdoor portion 110, such as an outdoor heat exchanger 120, outdoor fan 124, and compressor 126 may be enclosed within housing 114 between front opening 118 and rear opening 116. In certain example embodiments, one or more components of outdoor portion 110 are mounted on a base pan 136, as shown.

During certain operations, air may be drawn to outdoor portion 110 through rear opening 116. Specifically, an outdoor inlet 128 defined through housing 114 may receive outdoor air motivated by outdoor fan 124. Within housing 114, the received outdoor air may be motivated through or across outdoor fan 124. Moreover, at least a portion of the outdoor air may be motivated through or across outdoor heat exchanger 120 before exiting the rear opening 116 at an outdoor outlet 130. It is noted that although outdoor inlet 128 is illustrated as being defined above outdoor outlet 130, alternative example embodiments may reverse this relative orientation (e.g., such that outdoor inlet 128 is defined below outdoor outlet 130) or provide outdoor inlet 128 beside outdoor outlet 130 in a side-by-side orientation, or another suitable discrete orientation.

As shown, indoor portion 112 may include an indoor heat exchanger 122, a blower fan 142, and a heating unit (not shown). These components may, for example, be housed behind the front opening 118. A bulkhead 134 may generally support or house various other components or portions thereof of the indoor portion 112, such as the blower fan 142. Bulkhead 134 may generally separate and define the indoor portion 112 and outdoor portion 110 within housing 114. Additionally, or alternatively, bulkhead 134 or indoor heat exchanger 122 may be mounted on base pan 136 (e.g., at a higher vertical position than outdoor heat exchanger 120).

During certain operations, air may be drawn to indoor portion 112 through front opening 118. Specifically, an indoor inlet 138 defined through housing 114 may receive indoor air motivated by blower fan 142. At least a portion of the indoor air may be motivated through or across indoor heat exchanger 122 (e.g., before passing to bulkhead 134). From blower fan 142, indoor air may be motivated (e.g., across the heating unit, which may include one or more electric or resistive heating elements) and returned to an indoor area of a room through an indoor outlet 140 defined through housing 114 (e.g., above indoor inlet 138 along the vertical direction V). Optionally, one or more conduits (not pictured) may be mounted on or downstream from indoor outlet 140 to further guide air from air conditioner 100. It is noted that although indoor outlet 140 is illustrated as generally directing air upward, it is understood that indoor outlet 140 may be defined in alternative example embodiments to direct air in any other suitable direction. A temperature sensor 200 may be mounted in indoor outlet 140 to measure the temperature of the air inside indoor outlet 140. Additional temperature sensors may be used, e.g., on heat exchanger 122, or on the exterior of air conditioner 100. The exterior temperature sensor (not shown) may measure an ambient indoor air temperature.

Outdoor and indoor heat exchanger 120, 122 may be components of a thermodynamic assembly (i.e., sealed system), which may be operated as a refrigeration assembly (and thus perform a refrigeration cycle) or, in the case of the heat pump unit embodiment, a heat pump (and thus perform a heat pump cycle). Thus, as is understood, example heat pump unit embodiments may be selectively operated perform a refrigeration cycle at certain instances (e.g., while in a cooling mode) and a heat pump cycle at other instances (e.g., while in a heating mode). By contrast, example A/C exclusive unit embodiments may be unable to perform a heat pump cycle (e.g., while in the heating mode), but still perform a refrigeration cycle (e.g., while in a cooling mode).

The sealed system may, for example, further include compressor 126 (e.g., mounted on base pan 136) and an expansion device (e.g., expansion valve or capillary tube—not shown), both of which may be in fluid communication with the heat exchangers 120, 122 to flow refrigerant therethrough, as is generally understood. The outdoor and indoor heat exchanger 120, 122 may each include coils, as illustrated, through which a refrigerant may flow for heat exchange purposes, as is generally understood. The refrigerant may be a flammable refrigerant, such as chlorofluorocarbons (CFCs), hydrochlorofluorocarbons (HCFCs) and hydrofluorocarbons (HFCs) refrigerants.

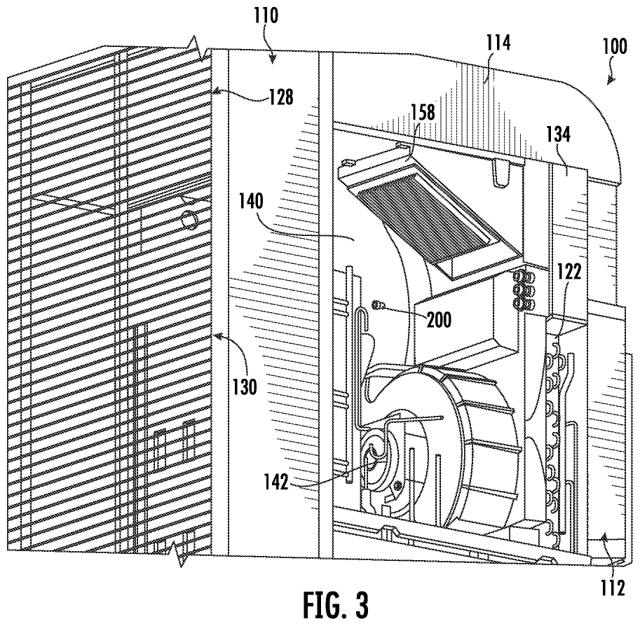

The operation of air conditioner 100 including compressor 126 (and thus the sealed system generally), blower fan 142, outdoor fan 124, the heating unit, and other suitable components may be controlled by a control board or controller 158 (FIG. 3). Controller 158 may be in communication (via for example a suitable wired or wireless connection) to such components of the air conditioner 100. By way of example, the controller 158 may include a memory and one or more processing devices such as microprocessors, CPUs or the like, such as general or special purpose microprocessors operable to execute programming instructions or micro-control code associated with operation of air conditioner 100. The memory may be a separate component from the processor or may be included onboard within the processor. The memory may represent random access memory such as DRAM, or read only memory such as ROM or FLASH.

Air conditioner 100 may additionally include a control panel and one or more user inputs, which may be included in control panel. The user inputs may be in communication with the controller 158. A user of the air conditioner 100 may interact with the user inputs to operate the air conditioner 100, and user commands may be transmitted between the user inputs and controller 158 to facilitate operation of the air conditioner 100 based on such user commands. A display may additionally be provided in the control panel and may be in communication with the controller 158. The display may, for example be a touchscreen or other text-readable display screen, or alternatively may simply be a light that can be activated and deactivated as required to provide an indication of, for example, an event or setting for the air conditioner 100.

Air conditioner 100 may include a separate analog hardware circuit, e.g., that does not include a controller. The hardware circuit may take a signal from blower fan 142 (either pulses over time or an analog output) and convert the signal into a direct current (DC) voltage that can be compared against a minimum threshold DC voltage. The minimum threshold DC voltage may be stored in a comparator of the analog hardware circuit to represent a minimum revolutions per minute, i.e., a speed of the fan 142, for which there may be sufficient airflow to activate a heater relay 550, heating unit (not shown), and/or a defrost heating element on heater exchanger 120, 122 (or any other ignition source). A Hall effect sensor may be coupled to the fan 142 to generate the output signal. The Hall effect sensor may be mounted directly to the fan blade as well as may be integrated into the motor of fan 142. In response to the DC voltage exceeding the minimum threshold, heating unit (not shown) and/or a defrost heating element on heater exchanger 120, 122 (or any other ignition source) may be permitted to activate. In response to the DC voltage being below the minimum threshold, heating unit (not shown) and/or a defrost heating element on heater exchanger 120, 122 (or any other ignition source) may be switched off, deactivated, and/or disabled, e.g., disabling relay 550 to the heater. In certain example embodiments, the fan feedback signal may still be passed through the separate analog hardware circuit unaffected to controller 158 for digital control purposes.

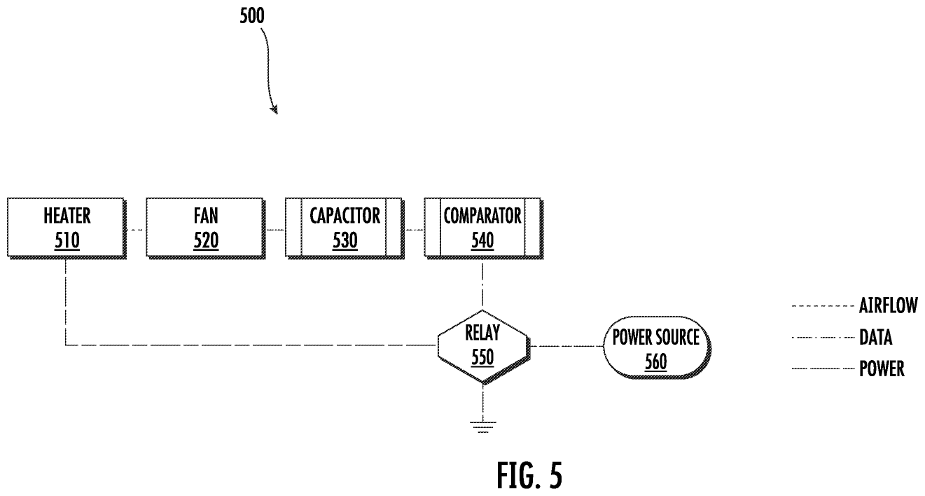

For example, blower fan 142 may generate pulses of the fan feedback signal. The hardware circuit may include a capacitor 530 (FIG. 5) to convert the fan feedback signal into a smooth DC voltage. The hardware circuit may further include a comparator 540 (FIG. 5) which includes a threshold DC voltage value to compare against the DC signal. In response to receiving the DC voltage from the fan feedback signal that exceeds the threshold, heating unit (not shown) and/or a defrost heating element on heater exchanger 120, 122 (or any other ignition source) may be permitted to operate. Comparator 540 may permit the heater relay to be closed in order to operate heating unit (not shown) and/or a defrost heating element on heat exchanger 120, 122. In response to receiving the DC voltage less than the threshold, heating unit (not shown) and/or a defrost heating element on heater exchanger 120, 122 (or any other ignition source) may be disabled. Comparator 540 may force the heater relay to ground, e.g., open relay 550, i.e., zero volts (0V), to disable operation of heating unit (not shown) and/or a defrost heating element on heat exchanger 120, 122.

In an additional or alternative example, blower fan 142 may generate pulses of the fan feedback signal. The hardware circuit may include capacitor 530 and a resistor (not shown) connected in series. Capacitor 530 and the resistor act as a high pass resistor-capacitor (RC) filter. The fan feedback signal applies directly to capacitor 530 with a resistor in parallel with the output. As such, high-frequency signals may pass, while capacitor 530 may block any frequencies that are too low. Thus, capacitor 530 may act as a closed circuit so long as the frequency of the signal stays above a minimum value. As long as there is a sufficient number of pulses of the fan feedback signal, the high-pass RC filter may permit the heater relay 550 to remain closed in order to operate resistance heating elements on heat exchangers 120, 122, heating unit, or other heat sources. In response to an insufficient number of pulses of the fan feedback signal, the high-pass RC filter may disable heater exchanger 120, 122 (or any other ignition source). The high-pass RC filter may force the heater relay to ground, e.g., open relay 550, i.e., zero volts (0V), to disable operation of resistance heating elements on heat exchanger 120, 122, heating unit, or other heat sources.

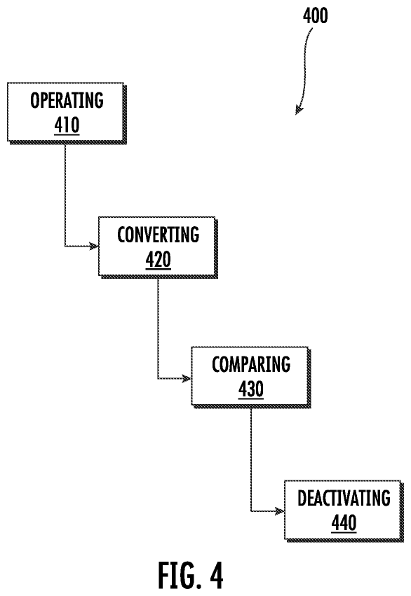

FIG. 4 illustrates method 400 of operating air conditioner 100. At 410, a fan of the appliance may be operating, such as blower fan 142. At 420, an output signal of blower fan 142 may be converted into a DC signal through capacitor 530. The output signal of the fan may be indicative of a speed of the fan, e.g., revolutions per minute. At. 430, the DC signal may be compared to a threshold value, for example, by comparator 540. Then at 440, a heater, such as heater exchanger 120, 122 (or any other ignition source) of air conditioner 100, may be deactivated in response to the DC signal being less than the threshold value. Additionally or alternatively, a heater relay may be in communication with comparator 540. Relay 550 may be configured to open in response to the DC signal being less than a threshold value, and to close in response to the direct current signal being greater than the threshold value. Thus, resistance heating elements on heat exchanger 120, 122, heating unit, or other heat sources may be activated or deactivated in response to the DC signal.

As referenced above, FIG. 5 illustrates a schematic 500 of an example hardware circuit 500 of the air conditioner 100. Heater 510, e.g., a resistance heating element on one of heat exchangers 120, 122 or heating unit, receives airflow from fan 520, i.e., blower fan 142. Fan 520 may have a Hall sensor coupled to fan 520 to send data, i.e., the fan feedback signal, to capacitor 530. The data signal is smoothed through capacitor 530 and continues to comparator 540. The smoothed signal may be compared to a threshold value by comparator 540, which is in communication with relay 550, i.e., the heater relay. Relay 550 may be in power connection with a power source 560, ground, and heater 510. Relay 550 may be configured to force the power to ground in response to the signal being less than the threshold value, and to connect heater 510 with power source 560 in response to the signal being greater than the threshold value. Thus, resistance heating elements on heat exchanger 120, 122, heating unit, or other heat sources may be activated or deactivated in response to the signal from fan 520 via hardware circuit 500.

As may be seen from the above, the separate hardware circuit may electronically read the fan speed output pulses in order to evaluate that blower fan 142 is spinning and moving air. The circuit may convert, without the use of software, the pulse signal into a DC voltage that enables or disables the heater relay of within air conditioner 100. Thus, providing a way of permitting or preventing components with ignition sources (e.g., heaters) from operating based on whether blower fan 142 is providing sufficient airflow.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An appliance, comprising:
a heater;
a fan configured for generating a fan feedback signal indicative of a speed of the fan;
a comparator in signal communication with the fan, the comparator configured to convert the fan feedback signal into a direct current signal;
a heater relay in communication with the comparator, the relay configured to open in response to the direct current signal being less than a threshold value and to close in response to the direct current signal being greater than the threshold value.

2. The appliance of claim 1, wherein the heater is activated when the heater relay is closed.

3. The appliance of claim 1, wherein the heater is deactivated when the heater relay is open.

4. The appliance of claim 1, wherein the fan comprises a Hall effect sensor coupled to a blade of the fan and configured to generate the fan feedback signal.

5. An appliance, comprising:
a heater;
a fan configured for generating pulses of a fan feedback signal indicative of a speed of the fan;
a resistor and a capacitor in signal communication with the fan, the resistor and the capacitor configured to identify a quantity of pulses of the fan feedback signal;
a heater relay in communication with the resistor and the capacitor, the relay configured to open in response to the quantity of pulses being less than a threshold value and to close in response to the quantity of pulses being greater than the threshold value.

6. The appliance of claim 5, wherein the heater is activated when the heater relay is closed.

7. The appliance of claim 5, wherein the heater is deactivated when the heater relay is open.

8. A method for operating an appliance, comprising:
operating a fan of the appliance;
converting an output signal of the fan into a direct current signal, the output signal of the fan indicative of a speed of the fan;
comparing the direct current signal to a threshold value; and
deactivating a heater of the appliance in response to the direct current signal being less than the threshold value.

9. The method of claim 8, wherein the fan comprises a Hall effect sensor coupled to a blade of the fan and configured to generate the output signal.

10. The method of claim 8, wherein the appliance comprises a capacitor and a comparator to convert the output signal of the fan into the direct current signal.

11. The method of claim 10, wherein the comparator compares the direct current signal to a threshold value.

12. The method of claim 11, wherein the appliance comprises a heater relay in communication with the comparator, the relay configured to open in response to the direct current signal being less than the threshold value and to close in response to the direct current signal being greater than the threshold value.

13. The method of claim 8, further comprising detecting a quantity of pulses of the output signal of the fan.

14. The method of claim 13, wherein the appliance comprises a resistor and a capacitor to detect the quantity of pulses of the output signal of the fan.

15. The method of claim 14, wherein the appliance comprises a heater relay in communication with the resistor and the capacitor, the relay configured to open in response to the quantity of pulses being less than a threshold quantity and to close in response to the quantity of pulses being greater than the threshold quantity.

16. The method of claim 8, further comprising activating the heater of the appliance in response to the direct current signal being greater than the threshold value.
